(19) United States
(12) Patent Application Publication
(10) Pub. No.: US 2015/0127481 A1
(43) Pub. Date: May 7, 2015

(54) METHOD AND SYSTEM FACILITATING INTERACTIONS OF A USER WITH A PERSON IN RELATION WITH THE USER

(71) Applicant: The Relationship Ninjas Canada Inc., Verdun (CA)

(72) Inventors: Gabriel Tupula Yamba, Montreal (CA); Phuc-Tue Le Dinh, Montreal (CA); Dai Nguyen, Verdun (CA)

(73) Assignee: The Relationship Ninjas Canada Inc., Verdun (CA)

(21) Appl. No.: 14/073,173

(22) Filed: Nov. 6, 2013

(51) Int. Cl. G06Q 30/06

(52) U.S. Cl. CPC G06Q 30/0631; G06Q 30/0633
USPC 705/26.7

(57) ABSTRACT

A method and a system facilitate interactions of a user with a person in relation with the user. A server detects an access from the user. The server fetches a profile of the person in relation with the user from a database. The profile includes at least a type for the relationship between the user and that person. Based on the relationship type, the server fetches a list of procurable gifts from one or more supplier servers. The list of procurable gifts is presented to the user. The user selects a gift and the server orders purchase of the selected gift from a supplier of the selected gift. The profile may include a shipping address and the purchase may comprise a request for delivery of the selected gift to the shipping address. Profiles may be defined for a plurality of persons in relation with the user.

### TECHNICAL FIELD

The present disclosure relates to the field of relationship facilitators. More specifically, the present disclosure relates to a method and a system for facilitating interactions of a user with a person in relation with the user.

### BACKGROUND

Remembering important events in the life of people around us, and denoting these events by gift offering is an important lubricant of social life. Gift giving upon holidays, birthdays and anniversaries can go a long way in showing one's care for another person. This applies to any type of relationship, whether business-oriented or family-oriented relations, but is especially important in romantic relations.

It is all too easy to let the swarm of day-to-day activities impede with the need to remember that a certain date is special for a certain person. While these situations can occur in any type of relationship, many men often tend to forget about important dates and events that they should remember and many women tend to be sensitive to acts of forgetfulness. Romantic relations may suffer from too many such situations.

There exist today a variety of services, for example Web services, aiming to facilitate social interactions. Some of them provide reminders about upcoming anniversaries, birthdays and holidays. Some provide suggestions and tips for improving social or romantic relations. Some of them sell gifts and provide suggestions for an appropriate gift for a particular situation or event. However, no comprehensive solution exists that integrate all necessary actions to ensure that gifts are properly selected and timely provided to another person.

Therefore, there is a need for solutions that compensate for people's tendency to forget about dates and events that are important for significant persons in their lives. Furthermore, there is a need for solutions that will curate and personalize gifts and also anticipate and predict these needs.

### SUMMARY

According to the present disclosure, there is provided a method of facilitating interactions of a user with a person in relation with the user. A server detects an access from the user. The server fetches from a database operably connected to the server a profile of the person in relation with the user. The profile comprises a relationship type. The server fetches from one or more supplier servers a list of procurable gifts based on the relationship type. The list of procurable gifts is presented to the user, by the server. The server receives, from the user, a choice of a selected gift. The server orders a purchase of the selected gift from a supplier of the selected gift.

The present disclosure also relates to a system for facilitating interactions of a user with a person in relation with the user. The system comprises a database and a server. The database stores a profile of the person in relation with the user. The profile comprises a relationship type. The server is operably connected to the database, is in communication with a terminal of the user, and is in communication with one or more supplier servers. A processor of the server is configured to detect a server access by the terminal of the user, fetch from the database the profile of the person in relation with the user, fetch from the one or more supplier servers a list of procurable gifts based on the relationship type, present to the terminal of the user the list of procurable gifts, receive from the terminal of the user, at the server, a choice of a selected gift, and order a purchase of the selected gift from a supplier of the selected gift.

The foregoing and other features will become more apparent upon reading of the following non-restrictive description of illustrative embodiments thereof, given by way of example only with reference to the accompanying drawings.

### BRIEF DESCRIPTION OF THE DRAWINGS

Embodiments of the disclosure will be described by way of example only with reference to the accompanying drawings, in which:

FIG. 1 is a flowchart of a method of facilitating interactions of a user with a person in relation with the user according to an aspect of the present disclosure;

FIG. 2 is a block diagram of a system for facilitating interactions of a user with a person in relation with the user according to another aspect of the present disclosure;

FIG. 3 is a flowchart to exemplify possible interactions supported by a server of the system of FIG. 2;

FIGS. 4, 5 and 6 are examples of web pages supported by the system of FIG. 2; and

FIGS. 7-10 collectively show a class diagram of software implemented in the server of FIG. 2 according to a non-limiting example.

### DETAILED DESCRIPTION

Various aspects of the present disclosure generally address one or more of the problems related to people's tendency to forget about dates and events that are important for significant persons in their lives.

In an aspect of the present disclosure, a user accesses a system server from a terminal, which may be a personal computer, a laptop computer, a personal assistant, a mobile terminal, an intelligent terminal, and the like. The access may be made on a web page supported by the system server. The user, having previously registered to the system, is authenticated by the system server. The server obtains from a database a list of persons (one or more) that the user has previously defined as “relations” for whom gifts and/or services will be purchased on special occasions. The database supplies a profile for each person in the list, the profile including at least a relationship type, for example a marital relationship or a parental relationship. Based on the relationship type, and possibly based on other information elements of the profile, the server obtains a list of procurable gifts from a variety of supplier servers. The list is presented to the user, generally as a web page. The user selects a gift and the server orders the purchase from the supplier of the selected gift.

Some of the following Figures will illustrate a particular use case in which the user is a male and the person in relation with the user is a female love interest. Several Figures show examples in which the addressee of a user is a woman and examples of gifts that a man would typically offer to a woman. The present technology is not limited to this particular use case and can be applied to any type of relationship between any two (or more) persons.

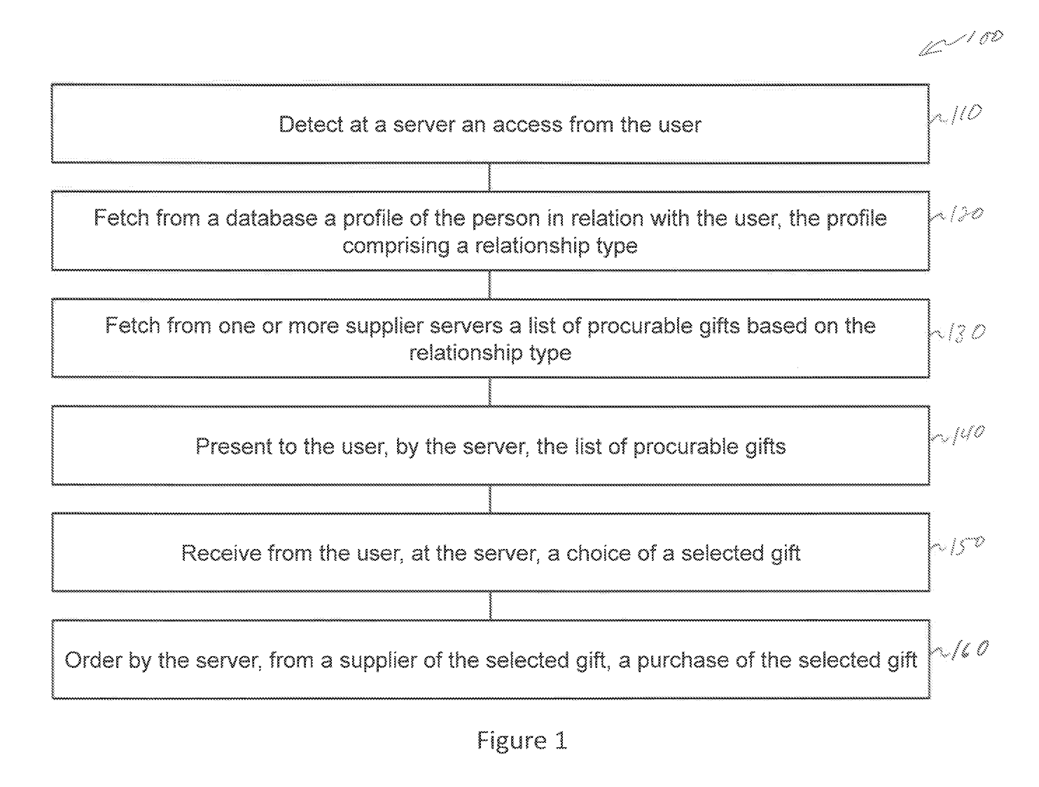

Referring now to the drawings, FIG. 1 is flowchart of a method of facilitating interactions of a user with a person in relation with the user according to an aspect of the present disclosure.

According to this method, a server detects an access from the user. The server fetches from a database operably connected to the server a profile of the person in relation with the user. The profile comprises a relationship type. The server fetches from one or more supplier servers a list of procurable gifts based on the relationship type and a personality type of the person in relation with the user. The list of procurable gifts is presented to the user, by the server. The server receives, from the user, a choice of a curated gift. The server orders a purchase of the curated gift from a supplier of the curated gift.

Shown on FIG. 1 is a sequence 100 comprising a plurality of operations that may be executed in variable order, some of the operations possibly being executed concurrently, some of the operations being optional. Operation 110 includes detecting an access from the user at a server. The server is connected to a database and fetches therefrom a profile of the person in relation with the user, the profile comprising a relationship type in operation 120. Operation 130 includes fetching from one or more supplier servers a list of procurable gifts based on the relationship type. The server presents the list of procurable gifts to the user at operation 140. The server receives, at operation 150, from the user, a choice of a selected gift. Operation 160 includes ordering by the server, from a supplier of the selected gift, a purchase of the selected gift.

The sequence 100 may include many options and variations. For example, when the profile of the person in relation with the user comprises a shipping address, the purchase of the selected gift comprises a request by the server, to the supplier of the selected gift, of a delivery of the selected gift to the shipping address. Without this shipping address of the person in relation with the user, the selected gift will be delivered to an address of the user.

In another variant, the profile of the person in relation with the user comprises a list of previously purchased gifts and/or services for that person. The list of procurable gifts presented to the user can be adjusted as a function of the list of previously purchased gifts, for example to avoid offering the same gift again. The user will usually receive feedback from the person receiving the gift; hopefully this feedback will be positive, but it might also be negative. A lack of feedback may also be perceived as some sort of negative feedback by the user. The user can provide to the server a score related to a previously purchased gift for the person in relation with the user. The server stores the score and an indication of the previously purchased gift in the profile of the person in relation with the user. Thereafter, adjusting the list of procurable gifts presented to the user as a function of the list of previously purchased gifts can be done as follows: If the score indicates that the previously purchased gift was not well-received, similar items are removed from the adjusted list of procurable gifts for the same person. If the score indicates that the previously purchased gift was well-received, the list of procurable gifts may be modified in various manners, depending on whether or not the previously purchased gift was a durable good. If the previously purchased gift having a favorable score was not a durable good, for example flowers, chocolates, a restaurant voucher, movie tickets, sports tickets, and the like, the same gift or similar items are included in the adjusted list of procurable gifts. If the previously purchased gift was a durable good, for example clothes, shoes, a car, jewelry, similar but not identical items are included in the adjusted list of procurable gifts.

Though not necessary, the profile of the person in relation with the user may comprise at least one significant date, for example a birthday, an anniversary, a religious holiday, a statutory holiday, a vacation day, a retirement day, valentine's day, mother's day and father's day, this list not being exhaustive of possible dates present in the profile. The server can compare the at least one significant date with a current time, for example with the current date. Fetching the list of procurable gifts and other operations of the sequence 100 may be made conditional to a remaining time between the at least one significant date and the current time being less than a predetermined threshold.

Alternatively, the server can compare a current time with a list of predetermined calendar dates, given that some dates are generally of great interest for most people (for example Christmas, New Year's Day, Easter, a national holiday) or for many relationship types (for example Valentine's day, mother's day, father's day, a graduation date). Fetching the list of procurable gifts and other operations of the sequence 100 may be made conditional to a remaining time between any one of the list of predetermined calendar dates and the current time being less than a predetermined threshold.

In another variant, the profile information of the person in relation with the user may include a start time of the relationship. The server can use this start time to determine an anniversary of the relationship or to calculate a factor representative of a value of the relationship based, for example, on the notion that a long-term relation may have more value.

Other information elements may be made part of the profile information of the person in relation with the user. For example and without limitation, the relationship type for a given person can be characterized by the person in relation with the user being, to the user, one of a spouse, a partner, a fiancée, a secret lover, a parent, a sibling, a child, a grandparent, a grandchild, a neighbor, a colleague, a boss, a client or a friend. In any of those cases, the relationship type can also be characterized by specifying the gender of the user or the gender of the person in relation with the user, or both.

Yet other information elements that may be made part of the profile information of the person in relation with the user may comprise any one of an age, a gender, a favorite color, a dress size, a shoe size, a food type, a clothes type, a designer name, an author, a sport, a movie type, a music type or any combination thereof.

At least in an embodiment of the present method that involves accessing the server via a web-based interface, the server may provide a profile menu to the user. Information elements entered by the user in the profile menu and received at the server are then stored in the database as part of the profile of the person in relation with the user. Optionally, the server may define that some information elements are mandatory—for example a relationship type—and deny entry of the profile menu if any mandatory information element is not supplied by the user.

While the foregoing has described operations and variants thereof for a sequence for facilitating interactions of a user with a person in relation with the user, the method may facilitate interactions of a plurality of users and, for each user, facilitate interactions with a plurality of other persons, each of whom having a distinct profile stored in the database. For example, the user may be a father and use the present method for facilitating his relationships with his two children. Another user may be the mother of the same children. Generally, each child will have distinct two profiles, one of which is determined by the father and another one determined by the mother.

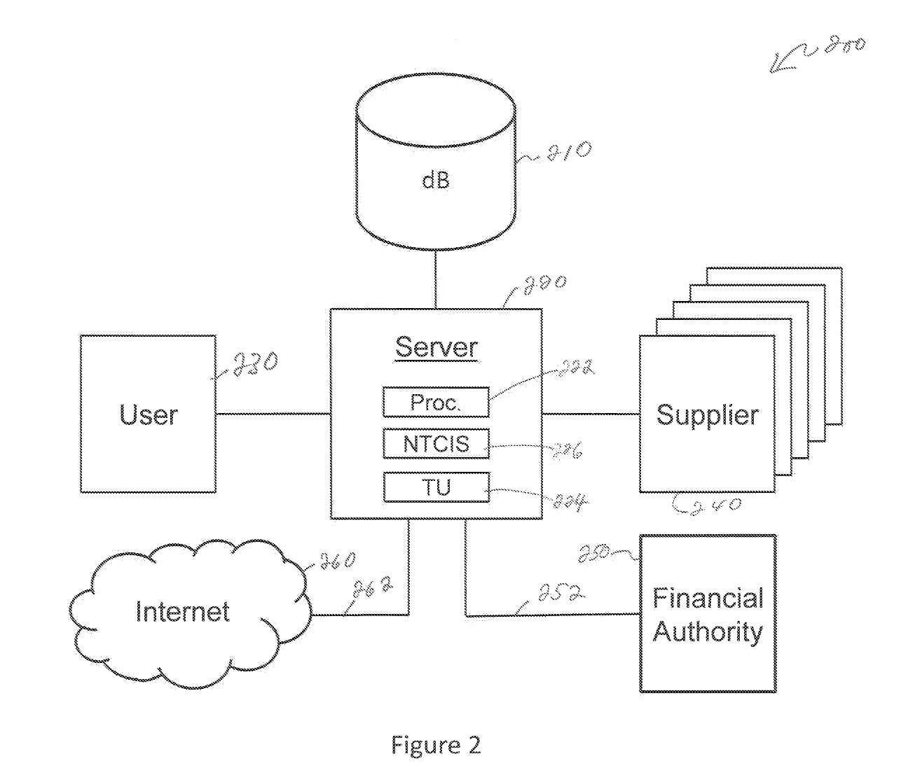

FIG. 2 is a block diagram of a system for facilitating interactions of a user with a person in relation with the user according to another aspect of the present disclosure.

By way of a general description, the system comprises a database and a server. The database stores a profile of the person in relation with the user. The profile comprises a relationship type and a personality type. The server is operably connected to the database, is in communication with a terminal of the user, and is in communication with one or more supplier servers. A processor of the server is configured to detect a server access by the terminal of the user, fetch from the database the profile of the person in relation with the user, fetch from the one or more supplier servers a list of procurable gifts based on the relationship type, present to the terminal of the user the list of procurable gifts, receive from the terminal of the user, at the server, a choice of a selected gift, and order a purchase of the selected gift from a supplier of the selected gift.

In more details, a system 200 comprises a database 210 and a server 220. The server 220, which may for example be a web server, is operably connected to the database 210; it can store data in the database 210 and can retrieve data therefrom. The server 220 has one or more communication interfaces (not specifically shown) allowing the system 200 to communicate with a terminal 230 of the user (more generally to a plurality of user terminals), with one or more supplier servers 240, with a financial authority 250, for example a bank or a credit card company, and with the Internet 260.

The database 210 stores a profile of the person in relation with the user, the profile comprising a relationship type. The server 220 comprises a processor 222 configured to detect an access at the server 220 by the terminal 230 of the user, fetch from the database 210 the profile of the person in relation with the user, fetch from the one or more supplier servers 240 a list of procurable gifts based on the relationship type, present to the terminal 230 of the user the list of procurable gifts, receive from the terminal 230 of the user a choice of a selected gift, and order a purchase of the selected gift from a supplier 240 of the selected gift.

The server 220 may include a dating and timing unit (TU) 224 operable to compare a current date and time with at least one significant date stored in the profile of the person in relation with the user. The dating and timing unit 224 can also compare the current data and time with a list of predetermined calendar dates. Alternatively, the dating and timing unit 224 can provide time information to the processor 222, which in turn can perform these time comparisons.

The server 220 can have a secure communication interface 252 toward the financial authority 250. The processor 222 can to obtain a credit validation of the user from the financial authority 250 before ordering the purchase of the selected gift.

The server 220 can be connected to the Internet 260, a link 262 between the server 220 and the Internet 260 is not required to be secure. The profile of the person in relation with the user, stored in the database 210 may include an identity of the person, including a real name of the person or a nickname of the person. The processor 222 can use the identity of the person to perform a data mining exploration, searching the Internet for information relevant to the person. For example, the identity of the person may lead to a social network website, for example Facebook™, and relevant information found on the Internet may be used to update the profile of the person in relation with the user based on this relevant information. As an example, when the person has indicated that she likes a given restaurant, her profile may be updated to indicate that she likes this restaurant or a type of food served at that restaurant. This may eventually lead to adding a gift certificate for a meal at that restaurant as a part of the list of procurable gifts for that person. Of course, obtaining relevant information from a broad array of web services identifiable with the identity of the person is also contemplated.

The processor 222 can execute all operations of the server of sequence 100, including all variants and options of the method of facilitating interactions of a user with a person in relation with the user, as described hereinabove. In particular, the server 220 or the database 210 or a combination of the server 220 and of the database 210 can include a non-transient computer information storage (NTCIS) device 226 (shown without limitation as a part of the server 220 in FIG. 2) operationally connected with the processor, the information storage device storing program instructions that, when executed by the processor 222, effect any one of the operations of the server of sequence 100, including all variants and options of the method of facilitating interactions of a user with a person in relation with the user, as described hereinabove.

Though FIG. 2 shows the server 220 and the database 210 as two distinct entities, integration of the database 210 within the server 220 is also contemplated. Moreover, though a single server 220 and a single database 210 are illustrated, the system 200 may comprise one or more servers and one of more databases, the number of servers not necessarily being equal to the number of databases. A plurality of servers and/or a plurality of databases may be employed for load-sharing and/or for reliability purposes. The system 200 for facilitating interactions of a user with a person in relation with the user may comprise a plurality of other elements and is greatly simplified for illustration purposes.

Various embodiments of the method and a system for facilitating interactions of a user with a person in relation with the user, as disclosed herein, may be envisioned. Such embodiments may comprise a definition of interactions supported by the server, a presentation of web pages supported by the server, and a class diagram of software implemented in the server.

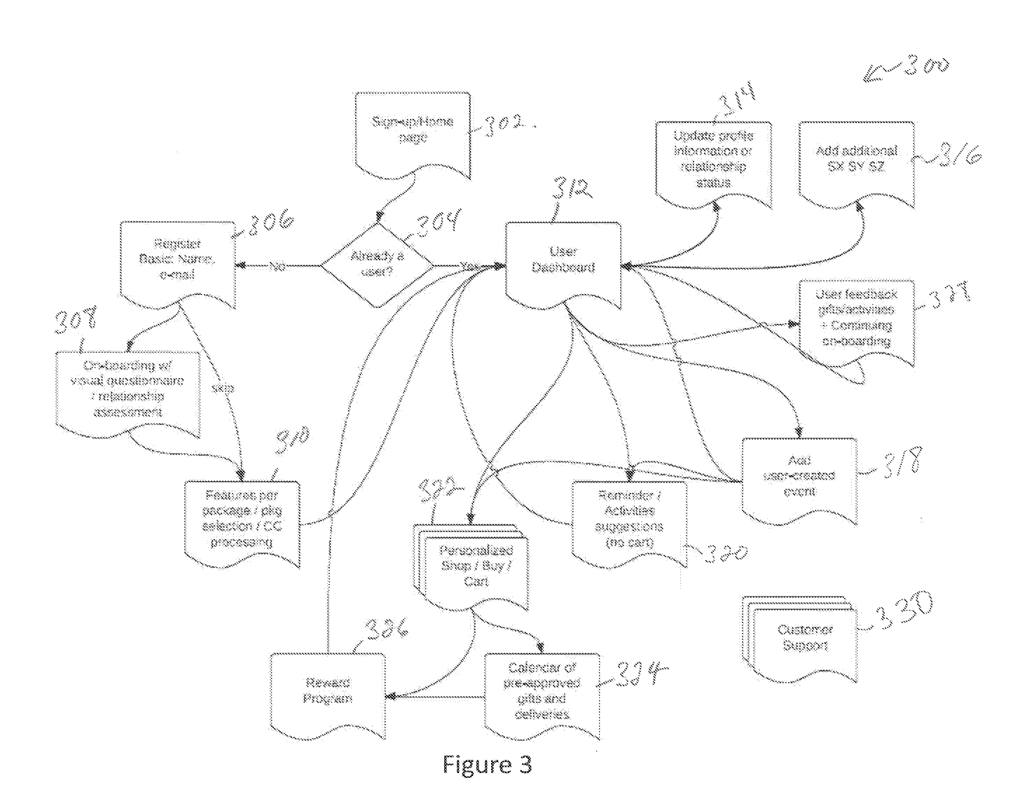

For example, FIG. 3 is a flowchart to exemplify possible interactions supported by a server of the system of FIG. 2. Shown on FIG. 3 is a sequence (300) comprising a plurality of operations that may be executed in variable order, some of the operations possibly being executed concurrently, some of the operations being optional. For illustration purposes, the server is a web server and supports a web site having a plurality of web pages, and each operation of the sequence (300), except operation 304, is implemented as a distinct web page of the web site.

The user logs in on a home page of the server (operation 302). The server verifies whether or not the user is already registered (304). If not, the server shows a registration page requesting some basic information (306). The user may access an on-board visual questionnaire for entering relationship information (308) or skip directly to a features selection page where he will select between basic or extended feature packages and enter his credit card information (310). Once registered, the user will have access to a user dashboard (312).

From the dashboard (312), the user can access a variety of services that terminate by returning directly or indirectly to the dashboard (312). The user can enter or update profile information for a person with whom he has a relation, or update his marital status (314), following which the sequence returns to the dashboard (312). The user can add one or more persons (figuratively identified as SX, SY and SZ on FIG. 3) with whom he has a relationship (316), especially if he has skipped the relationship information entry page (308). The user can define an event, for example a birthday of a person (318). From the dashboard (312) or directly following entry of an event (318) if there is limited remaining time, the user may be brought to a page reminding him of upcoming events and providing gift suggestions (320). From the dashboard (312) or directly following entry of an event (318) if there is limited remaining time, the user may be brought to a personalized shopping page where he will actually select a gift from a list of procurable gifts (322), the list being prepared by the system according to the above described method.

Having selected a gift, the user will see a calendar page showing pre-approved gifts and planned deliveries (324). The system may be complemented with a reward program based on a number and amount of purchases, in which case the user is brought to a reward page that he can consult to see how many reward points have been accumulated (326).

When a gift has been delivered, the user can log in again to enter feedback on past gifts and activities (328), providing a score that will be placed in the profile of the person having benefited from the gift or activity.

At any time after logging in, the user may access a customer support page (330).

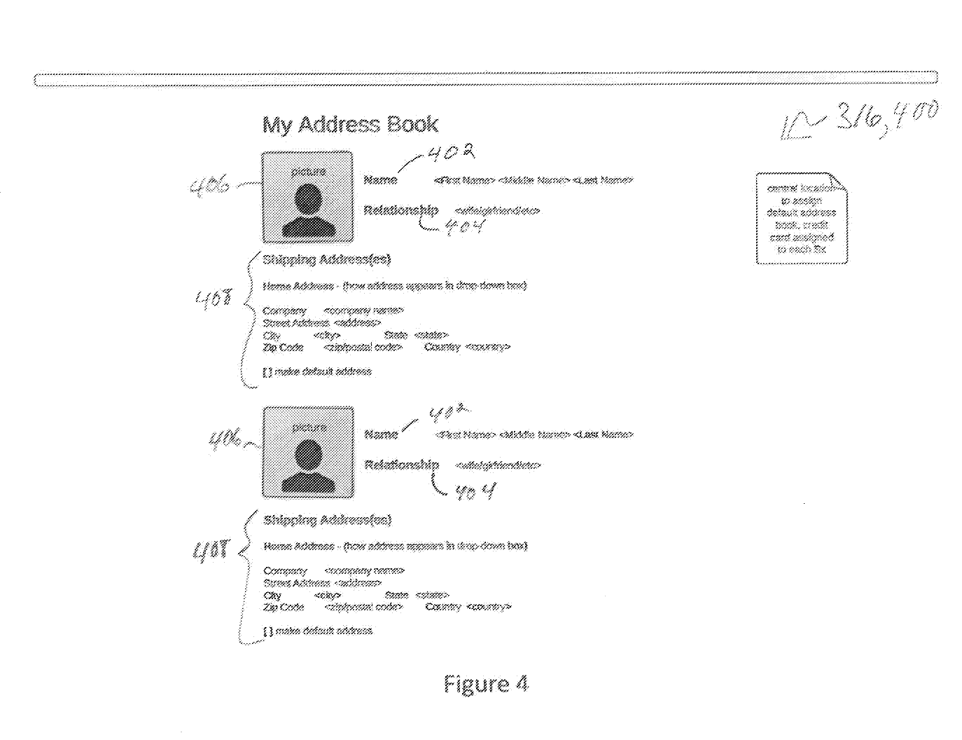

FIGS. 4, 5 and 6 are examples of web pages supported by the system of FIG. 2. FIG. 4 shows an address book 400 on which the user can enter information about persons with whom he has a relation. The page corresponds to the operation 316 described hereinabove. The user enters a name, 402 a relationship type 404 and may include a shipping address 408 for direct delivery of gifts to that person. The name 402, the relationship type 404 and the shipping address 408 are made part of the profile for that person. A picture 406 of the person may also be uploaded on the address book 400. The address book 400 may contain these information elements for a plurality of persons having a relationship with the user.

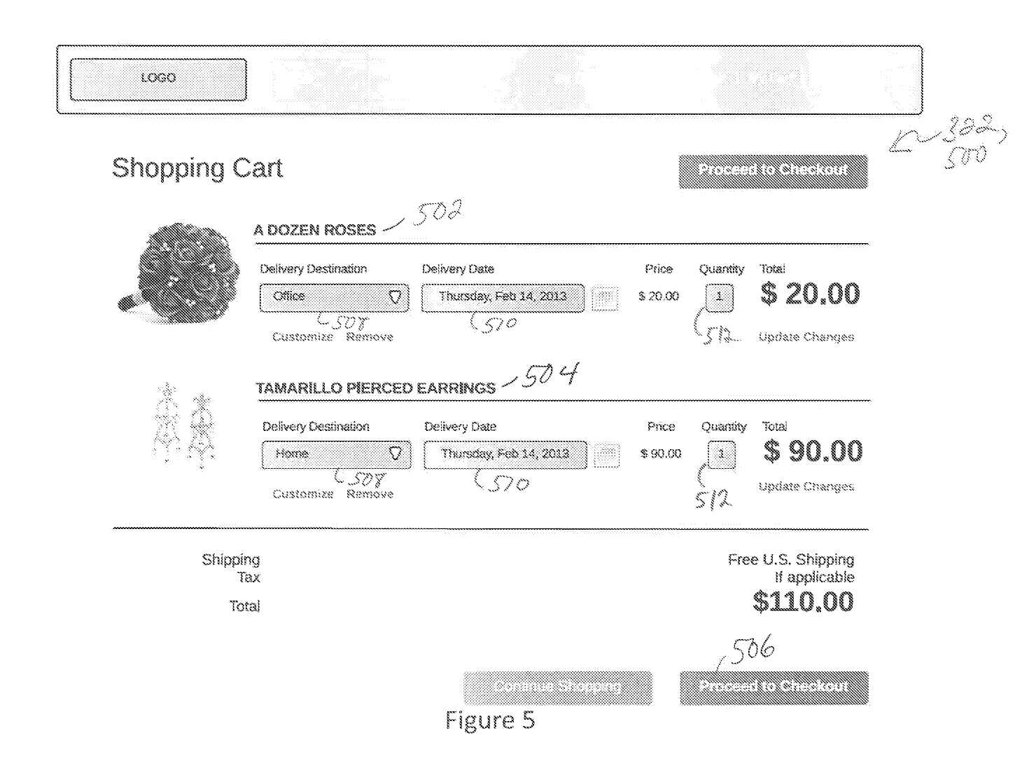

FIG. 5 shows a shopping cart 500 and corresponds to operation 322. The page shows a list of two (2) procurable gifts 502, 504 for a person having a relationship with the user; the list of procurable gifts is however not so limited and may include any number of procurable gifts. The list is presented as a menu page and the user can select 0, 1 or more of each item 502, 504 in the list, using button 512, before proceeding to checkout 506. Checking out actuates ordering by the server, from a supplier of a selected gift, of a purchase of the selected gift. The shopping cart 500 includes other information elements, for example a delivery destination 508, which corresponds to at least one shipping address 408 for a person having a relationship with the user, and a delivery date 510, which corresponds to a significant event date for that person. Other elements shown on FIG. 5 are self-explanatory.

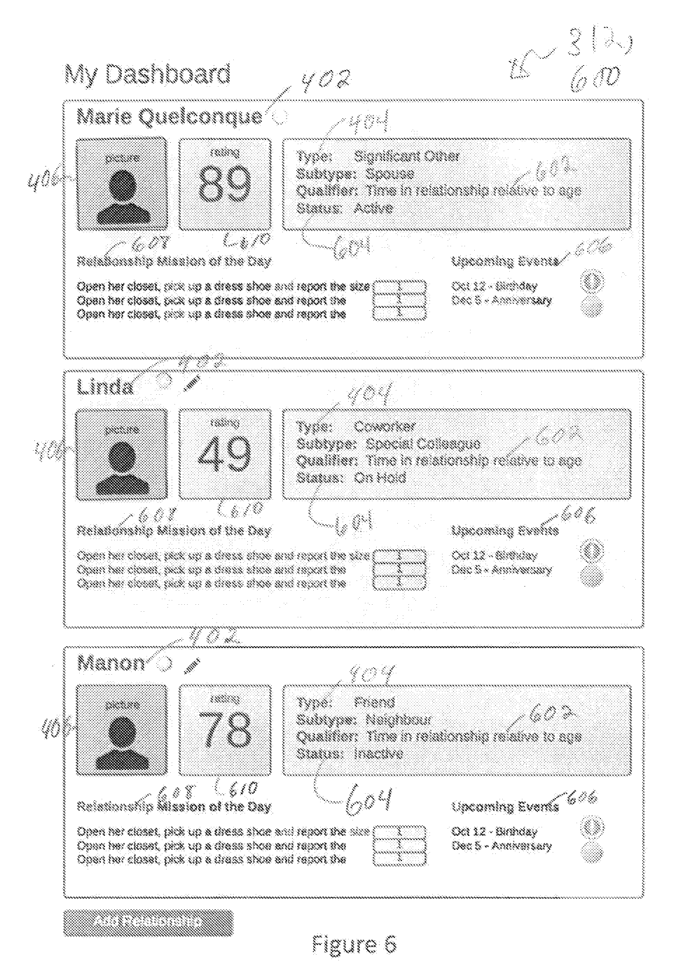

FIG. 6 shows a dashboard page 600, corresponding to operation 312. It includes, for each person having a relationship with the user, her name 402 (either a real name or a nickname), a relationship type 404, a picture 406, a time in relation relative to age 602, and an activity status 604 for the relationship. The activity status 604 of the relationship may be added to the profile information of the person in relation with the user. The dashboard page 600 summarizes upcoming events 606 (used to define the delivery date 510 on the shopping cart 500) for each person and further provides helpful tips 608 for enhancing the person's profile. A relationship rating 610 is calculated according to a level of past activities of the user for that person.

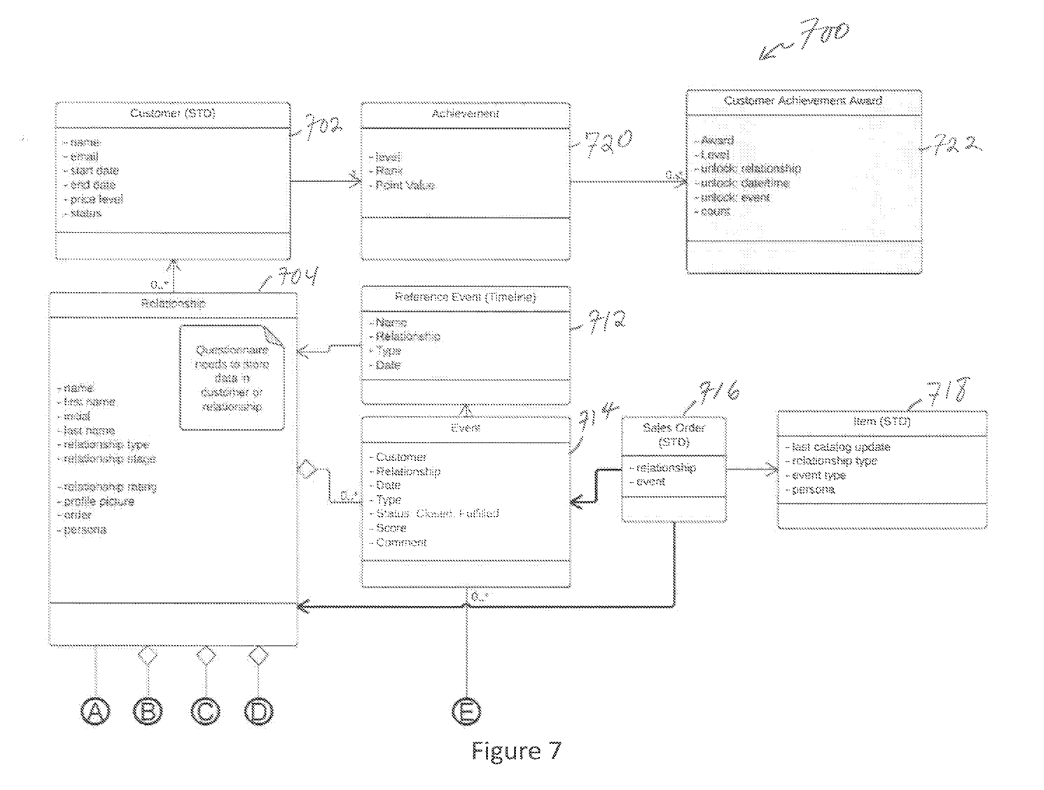

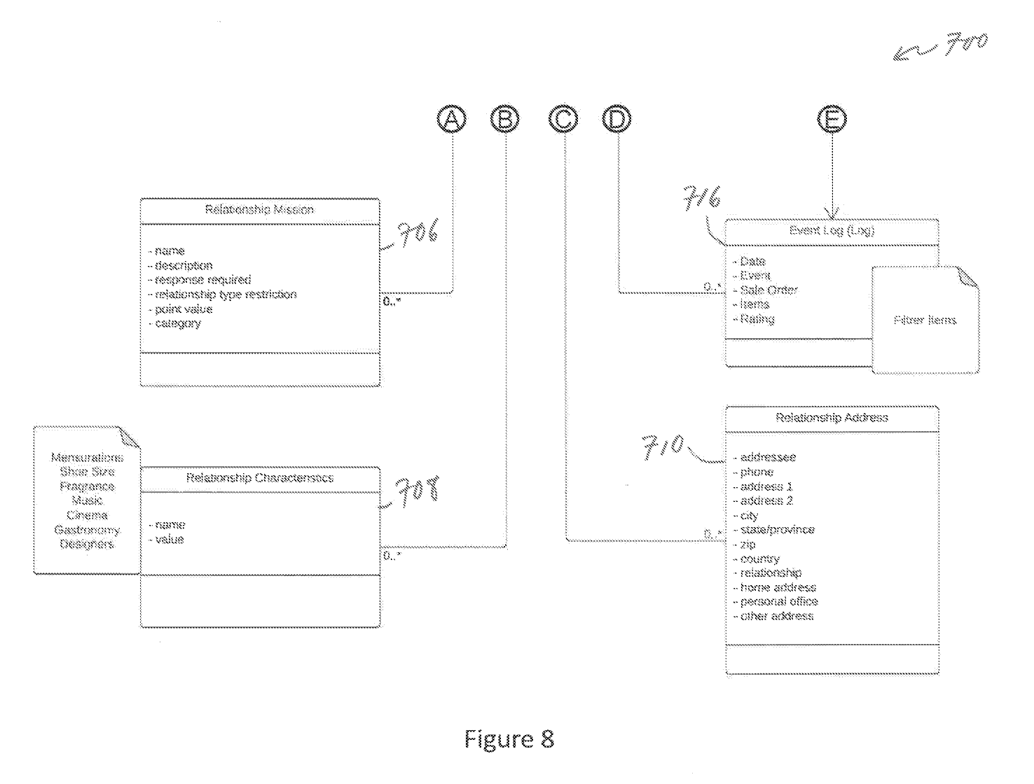

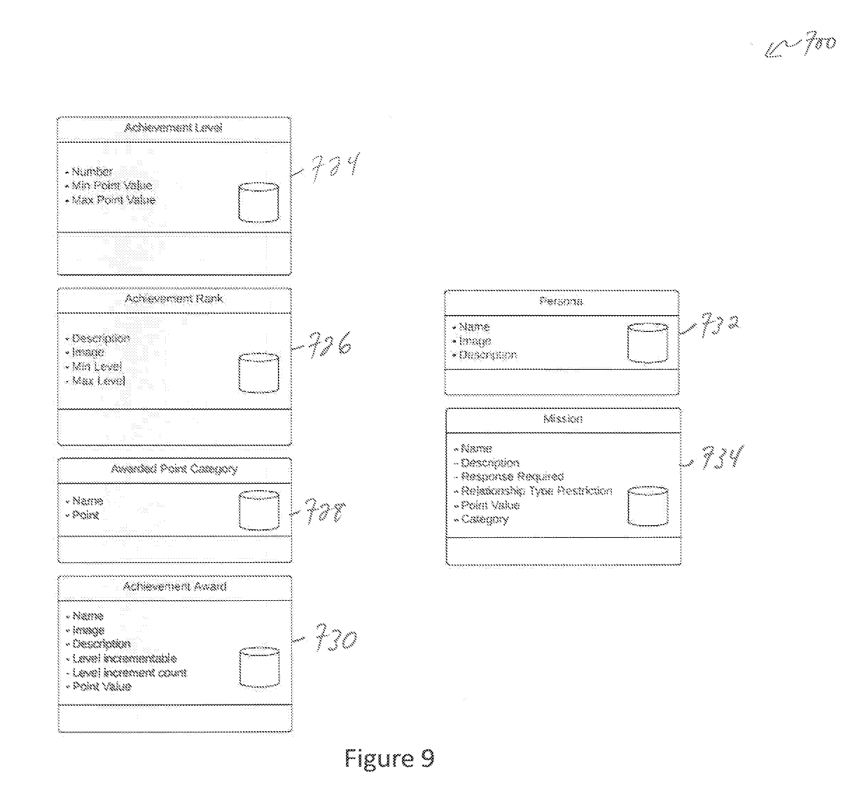

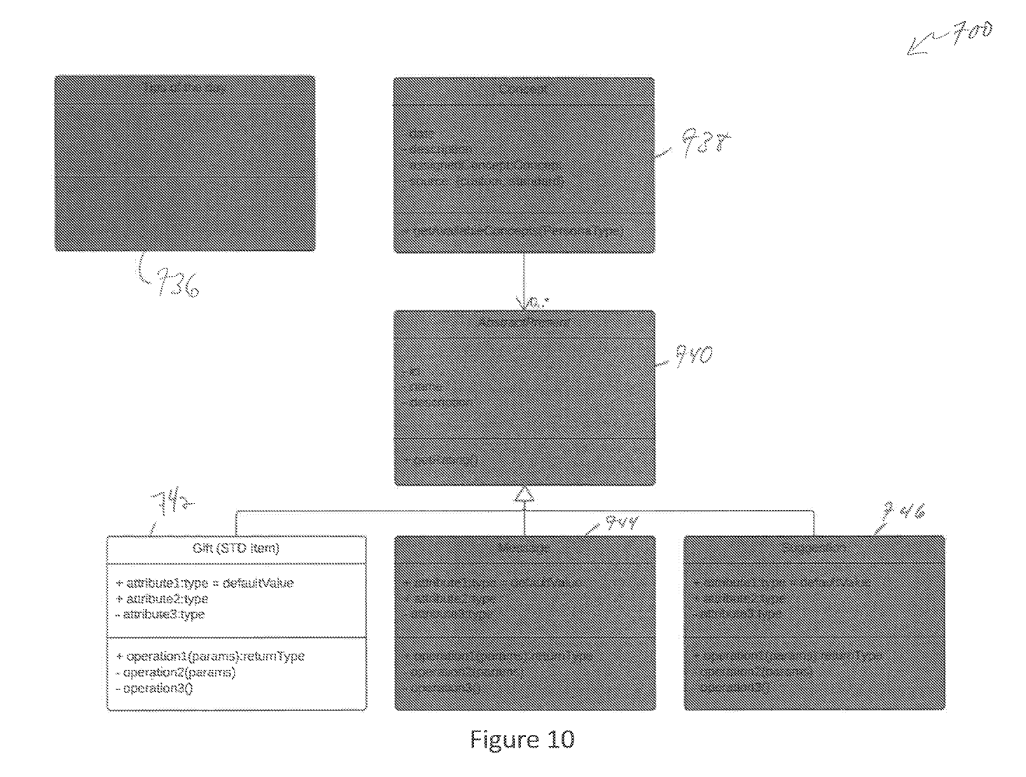

FIGS. 7-10 collectively show a class diagram of software implemented in the server of FIG. 2 according to a non-limiting example. In a class diagram 700, some relationships between objects visible on FIGS. 7 and 8 are denoted by connectors marked A, B, C, D and E.

A customer 702 has zero or more persons with whom he has a relationship 704. Each relationship 704 has a mission 706, characteristics 708, address information 710, a timeline of significant events 712, an events list 714 and a past events log 716. Each relationship 704 can be associated with a sales order 718 for a particular event; the sales order 716 involving a list of procurable items 718. Purchases made by the customer 702 are recorded as achievements 720 and, when sufficient award points have been collected, an achievement award 722 for the customer 702 may be provided.

Continuing with the collection of award points, standard achievement levels 724 are defined in the system. A ranking 726 is calculated based on the achievement levels 724. Users can be awarded points according to a category 728 following each purchasing event. A particular achievement award 730 is defined for a user having reached a corresponding point value, the award 730 including a description of a product or service offered to the user when meeting this point value.

A persona object 732 is used for the definition of information designating a person with whom a user has a relationship. A mission 734 provides inputs for defining the helpful tips 608 appearing on the dashboard page 600. Another object that may be defined in the class diagram includes tips of the day 736 that may be presented on the dashboard page 600 of any user.

Objects 738 to 746 provide a software structure for the insertion of procurable gift suggestions on the shopping cart 500. A variety of gifts are defined as specific gift items 742. The available gift items 742 are combinable with a corresponding message 744 and with a suggestion 746 to form abstract gift presentations 740. A gift concept 738 makes a selection among the variety of available gifts based in part on a relationship type (Persona Type) and on the abstractions of the gifts 740, and places the chosen items on the shopping cart 500.

Those of ordinary skill in the art will realize that the description of the method and a system for facilitating interactions of a user with a person in relation with the user are illustrative only and are not intended to be in any way limiting. Other embodiments will readily suggest themselves to such persons with ordinary skill in the art having the benefit of the present disclosure. Furthermore, the disclosed method and system may be customized to offer valuable solutions to existing needs and problems of people forgetting about dates and events that are important for significant persons in their lives.

In the interest of clarity, not all of the routine features of the implementations of method and system are shown and described. It will, of course, be appreciated that in the development of any such actual implementation of the method and system, numerous implementation-specific decisions may need to be made in order to achieve the developer's specific goals, such as compliance with application-, system-, network- and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of relationship facilitators having the benefit of the present disclosure.

In accordance with the present disclosure, the components, process operations, and/or data structures described herein may be implemented using various types of operating systems, computing platforms, network devices, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used. Where a method comprising a series of operations is implemented by a computer or a machine and those operations may be stored as a series of instructions readable by the machine, they may be stored on a tangible medium.

Systems and modules described herein may comprise software, firmware, hardware, or any combination(s) of software, firmware, or hardware suitable for the purposes described herein. Software and other modules may reside on servers, workstations, personal computers, computerized tablets, personal digital assistants (PDA), and other devices suitable for the purposes described herein. Software and other modules may be accessible via local memory, via a network, via a browser or other application or via other means suitable for the purposes described herein. Data structures described herein may comprise computer files, variables, programming arrays, programming structures, or any electronic information storage schemes or methods, or any combinations thereof, suitable for the purposes described herein.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A method of facilitating interactions of a user with a person in relation with the user, comprising:
detecting at a server an access from the user;
fetching from a database operably connected to the server a profile of the person in relation with the user, the profile comprising a relationship type;
fetching from one or more supplier servers a list of procurable gifts based on the relationship type;
presenting to the user, by the server, the list of procurable gifts;
receiving from the user, at the server, a choice of a selected gift; and
ordering by the server, from a supplier of the selected gift, a purchase of the selected gift.

2. The method of claim 1, wherein the profile of the person in relation with the user comprises a shipping address and wherein the purchase of the selected gift comprises a request for delivery of the selected gift to the shipping address.

3. The method of claim 1, wherein the profile of the person in relation with the user comprises a list of previously purchased gifts for the person in relation with the user and wherein the list of procurable gifts presented to the user is adjusted as a function of the list of previously purchased gifts.

4. The method of claim 3, comprising:
receiving from the user, at the server, a score related to a previously purchased gift; and
storing the score and an indication of the previously purchased gift in the profile of the person in relation with the user.

5. The method of claim 4, wherein adjusting the list of procurable gifts presented to the user as a function of the list of previously purchased gifts comprises:
if the score indicates that the previously purchased gift was not well-received, excluding similar items from the adjusted list of procurable gifts;
if the score indicates that the previously purchased gift was well-received:
if the previously purchased gift was not a durable good, including the same gift or similar items in the adjusted list of procurable gifts; and
if the previously purchased gift was a durable good, including similar items in the adjusted list of procurable gifts.

6. The method of claim 1, wherein the profile of the person in relation with the user comprises at least one significant date.

7. The method of claim 6, comprising:
comparing, by the server, the at least one significant date with a current time;
conditionally fetching the list of procurable gifts if a remaining time between the at least one significant date and the current time is less than a predetermined threshold.

8. The method of claim 6, wherein one of the at least one significant date is selected from a birthday, an anniversary, a religious holiday, a statutory holiday, a vacation day, a retirement day, valentine's day, mother's day and father's day.

9. The method of claim 1, comprising:
comparing, by the server, a current time with a list of predetermined calendar dates;
conditionally fetching the list of procurable gifts if a remaining time between any one of the list of predetermined calendar dates and the current time is less than a predetermined threshold.

10. The method of claim 1, wherein the relationship type is characterized by the person in relation with the user being, to the user, one of a spouse, a partner, a fiancée, a secret lover, a parent, a sibling, a child, a grandparent, a grandchild, a neighbor, a colleague, a boss, a client or a friend.

11. The method of claim 10, wherein the relationship type is further characterized by specifying the gender of the user or the gender of the person in relation with the user, or both.

12. The method of claim 1, comprising:
providing a profile menu, by the server, to the user;
receiving, at the server, information elements entered by the user in the profile menu; and
storing in the database, by the server, the received information elements as part of the profile of the person in relation with the user.

13. The method of claim 1, wherein the profile information of the person in relation with the user further includes an activity status of the relationship.

14. The method of claim 1, wherein the profile information of the person in relation with the user further includes a start time of the relationship.

15. The method of claim 1, wherein the profile information of the person in relation with the user further comprises an element selected from an age, a gender, a favorite color, a dress size, a shoe size, a food type, a clothes type, a designer name, an author, a sport, a movie type, a music type or a combination thereof.

16. The method of claim 1, wherein the user is in relation with a plurality of other persons and wherein the database stores a profile for each of the plurality of other persons.

17. A system for facilitating interactions of a user with a person in relation with the user, comprising:
a database storing a profile of the person in relation with the user, the profile comprising a relationship type; and
a server, operably connected to the database, in communication with a terminal of the user, and in communication with one or more supplier servers, the server comprising a processor configured to:
detect a server access by the terminal of the user;
fetch from the database the profile of the person in relation with the user;
fetch from the one or more supplier servers a list of procurable gifts based on the relationship type;
present to the terminal of the user the list of procurable gifts;
receive from the terminal of the user a choice of a selected gift; and
order a purchase of the selected gift from a supplier of the selected gift.

18. The system of claim 17, comprising a dating and timing unit operable to compare a current date and time with at least one significant date stored in the profile of the person in relation with the user or with a list of predetermined calendar dates.

19. The system of claim 17, comprising a secure communication interface of the server toward a financial authority, the processor being further configured to obtain credit from the financial authority before ordering the purchase of the selected gift.

20. The system of claim 17, wherein:
the profile of the person in relation with the user includes an identity of the person;
the processor is further configured to use the identity of the person to search the Internet for information relevant to the person; and
the processor is further configured to update the profile of the person in relation with the user based on relevant information found on the Internet.
